(19) United States
(12) Patent Application Publication
(10) Pub. No.: US 2016/0143326 A1
(43) Pub. Date: May 26, 2016

(54) Production Line And Method For Making Ice-Noodle

(71) Applicant: MohammadMehdi Misagh, Shiraz (IR)

(72) Inventor: MohammadMehdi Misagh, Shiraz (IR)

(73) Assignee: MohammadMehdi Misagh, Shiraz (IR)

(21) Appl. No.: 15/004,958

(22) Filed: Jan. 24, 2016

(51) Int. Cl. A23G 9/22; B01F 7/08; A23L 1/212

(52) U.S. Cl. CPC A23L 1/16; B01F 7/08; A23V 2002/00

(57) ABSTRACT

The present invention discloses a production line and a method for manufacturing pasteurized ice-noodles with more durability and in different tastes.

Ice-noodle (Faloudeh) is one of the most delicious foods in the world, its taste is amazing and eating ice-noodle is grate especially in warm summers.

Making ice-noodle with traditional methods, will cause the product be infected and not pasteurized and the shape of product will change after a day so the durability of the product is not suitable for exporting.

The production line of this invention comprises three lines, one for making syrup, one for making fiber starch and the last one for mixing the syrup and the fiber starch.

### CROSS REFERENCE TO RELATED APPLICATION

The present application claims the benefit and the priority of the U.S. Provisional Patent application Ser. No.: 62/119,834 filed on Feb. 24, 2015 with title, “Industrial Ice-Noodle Manufacturing”, and the contents of which is incorporated in its entirety as reference herein.

### TECHNICAL FIELD OF INVENTION

The present invention relates to some apparatus and a method for making pasteurized ice-noodles.

### BACKGROUND

In traditional methods for making ice-noodles, first step is baking mixture of water and starch in a big pot containing a mixture for about 20 to 25 minutes until the color of the starch turns clear and glassy. The next step is extruding starch by pressing and releases it in some pots filled with cold water.

Then the cold extruded starch will mix with frozen mixture of water and sugar this product should keep in freezer for almost 2 hours.

In this method, there is not any special equipment required and the durability for this product will be one or utmost two days and there should be many different bacteria in product undoubted because of the non-pasteurized described making method.

### SUMMARY

The present invention discloses a production line and a method for manufacturing pasteurized ice-noodles with more durability and in different tastes.

Ice-noodle (Faloudeh) is one of the most delicious foods in the world, its taste is amazing and eating ice-noodle is grate especially in warm summers.

In this method in first step, starch should solve in enough water in a mixer then it will bake with indirect heat in 93° C. the mixture will become fiber by pressing and combine with cold water automatically. Moreover, the water and sugar used for thick syrup are pasteurized and become frozen in −18 temperate.

In the next step the fiber starch and syrup mix together automatically in a machine for almost 30 minutes, then some concentrated and crashed fruit would add to mixture and they would mix again, in this step the temperature and mixing time should be under control for leading high quality and suitable texture.

After these steps, the ice-noodle is ready for packing.

As result, the ice noodle product would be in different tastes such as vegetables, distillates, pasteurized saffron, pasteurized fruit etc.

### BRIEF DESCRIPTION OF THE DRAWINGS

FIG. 1 shows the production line. In this Figure, number 1 shows the syrup makings line, number 2 shows fiber starch's making line and number 3 shows the mixings line.

FIG. 2 shows the syrup makings line in which number 1 is a table for mixing sugar with a little water and some additives, number 2 is a pump for transferring the sugar and water to a storage (3). There is water in the storage, sugar would add to this water and mix with it by a mixer until it is sweet enough then it would transfer to another storage (4) with pump. Number 5 shows Pasteurizer, number 6 shows Homogenizer number 7 is storage and number 8 shows mixer freezer.

FIG. 3 shows fiber starch makings line in which number 9 is starch mixer, number 10 is a two shell mixer in which baking starch occur, number 11 is a kind of net pod, number 12 is pressing arm, number 13 is cold-water pool and number 14 is a conveyer.

FIG. 4 and FIG. 6 show some views of cold-water pool, net pod, pressing arm and conveyer.

FIG. 5 shows an isometric view of net pot and pressing arm.

FIG. 7 shows storage with a mixer in it.

FIG. 8 and FIG. 9 shows finale mixings line in which syrup and fiber starch would mix.

### DETAILED DESCRIPTION OF THE INVENTION

The main purpose of the present invention is to disclose industrial ice-noodle manufacturing for baking, fast cooling and mixing together with high quality and in more hygienic ways by utilizing the means and ways such as pasteurization.

The main goal of this invention is to produce pasteurized ice-noodle with high durability and with different tastes such as vegetable distillates, pasteurized saffron, pasteurized fruit and mixed with fruit etc.

The production line of this invention has three different sections.

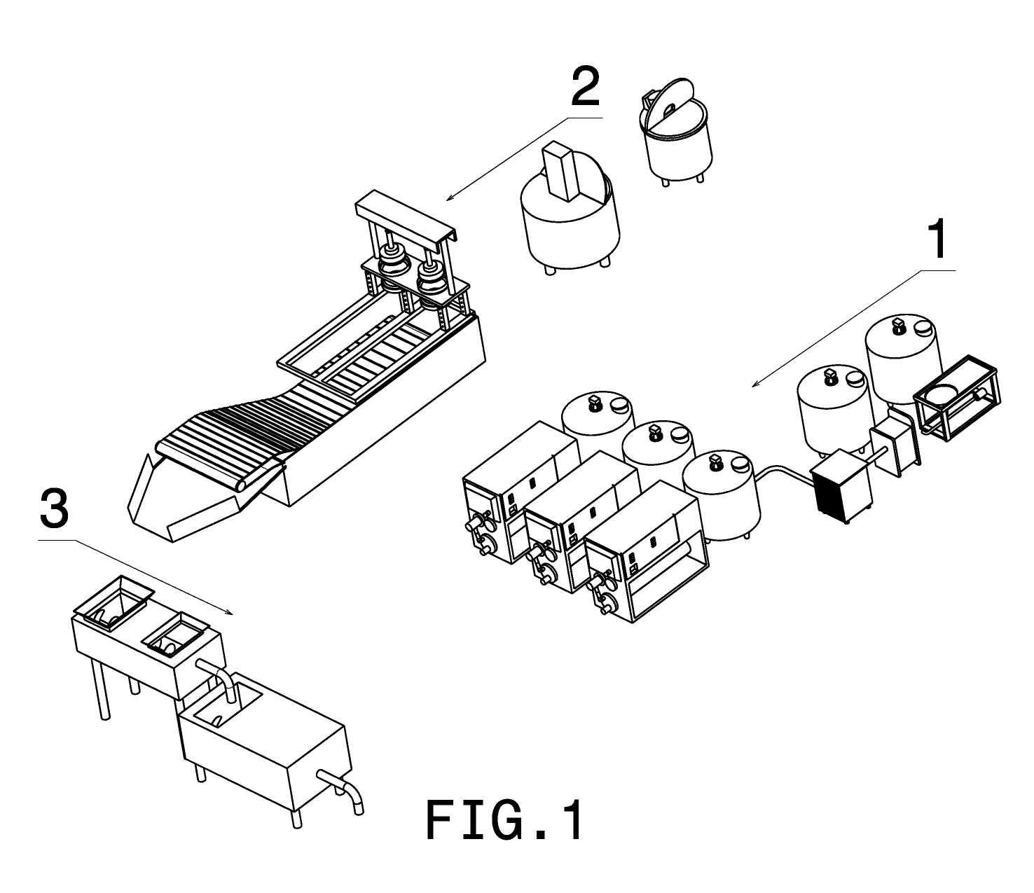

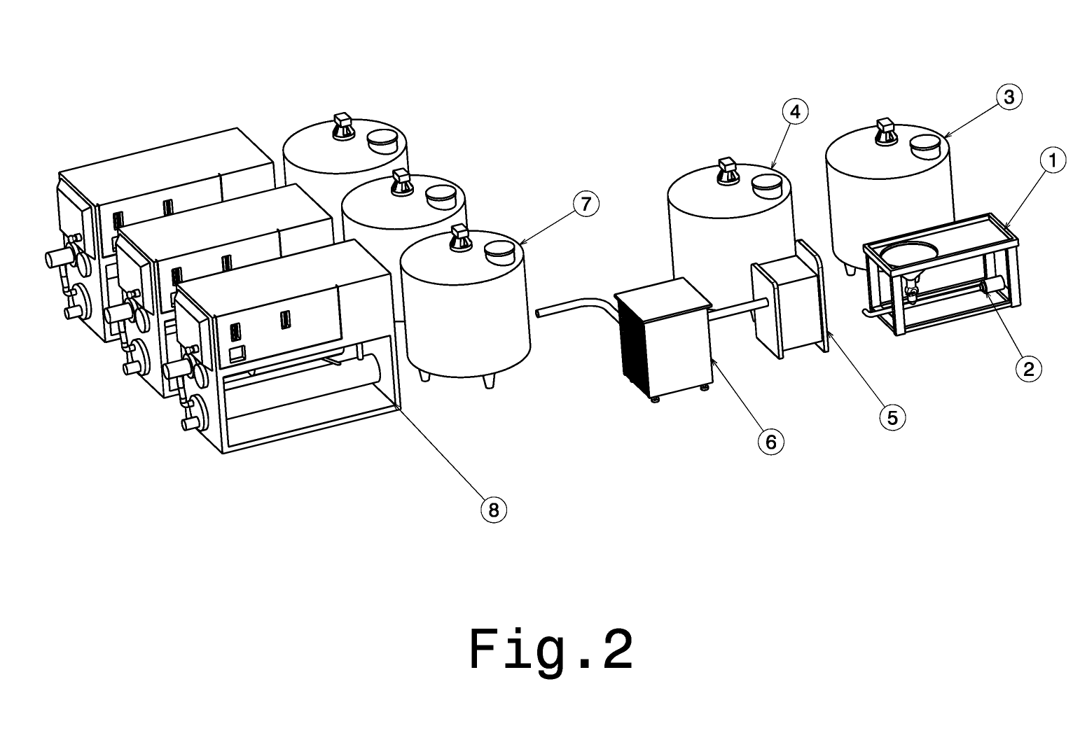

The first section of this production line is a line for making syrup (FIG. 1 number 1) in which water, sugar and stabilizer and or any other flavors mix in a mixer (FIG. 2 number 3).

A pump transfer sugar and other additives to a storage. There is water in the storage, sugar would add to this water and mix with it by a mixer until it is sweet enough, then it would transfer to another storage by a pump. There can be a pre-heater mechanism in this line in which the temperature of the mixture would increase therefore we would have a uniform mixture.

Next section of this line is pasteurization section (FIG. 2 number 5) in which the temperature of the mixture would increase up to 83° C.

The next section is homogenization (FIG. 2 number 6) section in which the mixture would homogenize under 200-bar pressure and we would have an equal mixture.

This section comprises of a pump and nozzle and homogenizes the mixture by shooting it with high velocity.

Then the mixture would save in storage (FIG. 2 number 7) and cool off in freezer section (FIG. 2 number 8), which has a mixer inside, and the mixture will bring out from freezers in −18° C. and we would have an icy syrup which is ready for being mix with fiber starch.

The second section of the production line is a line for making fiber starch. (FIG. 1 number 2)

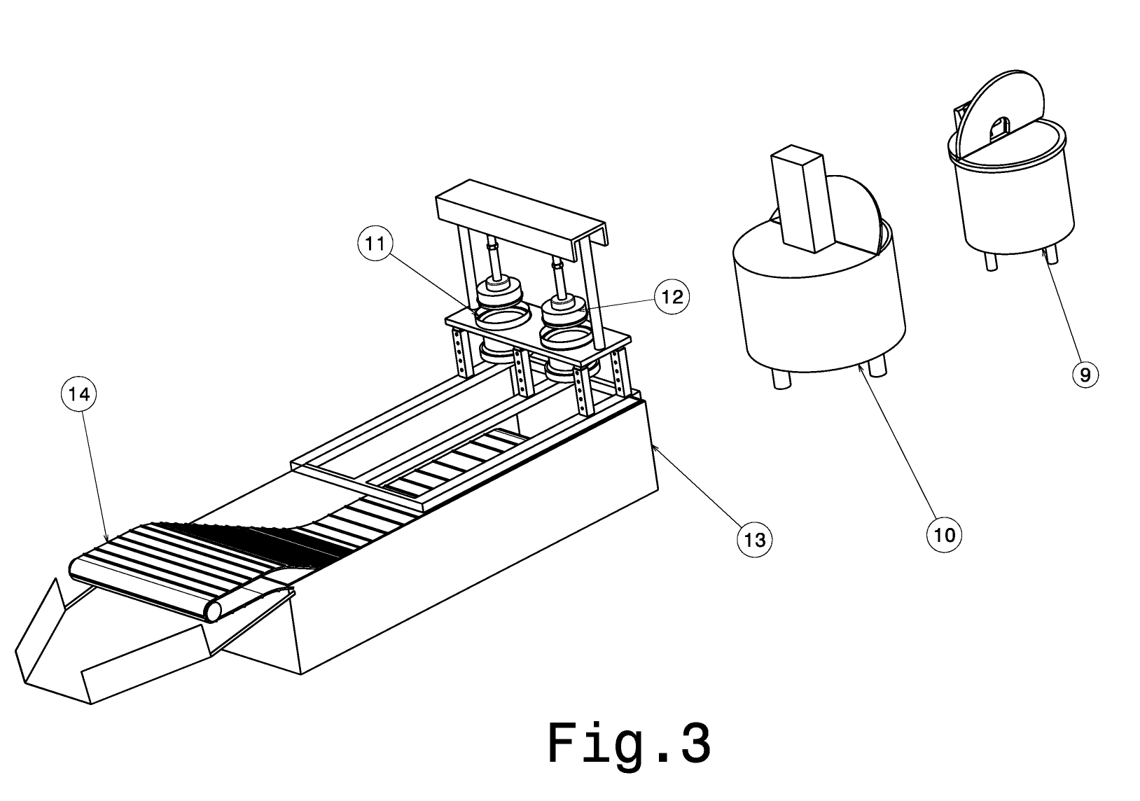

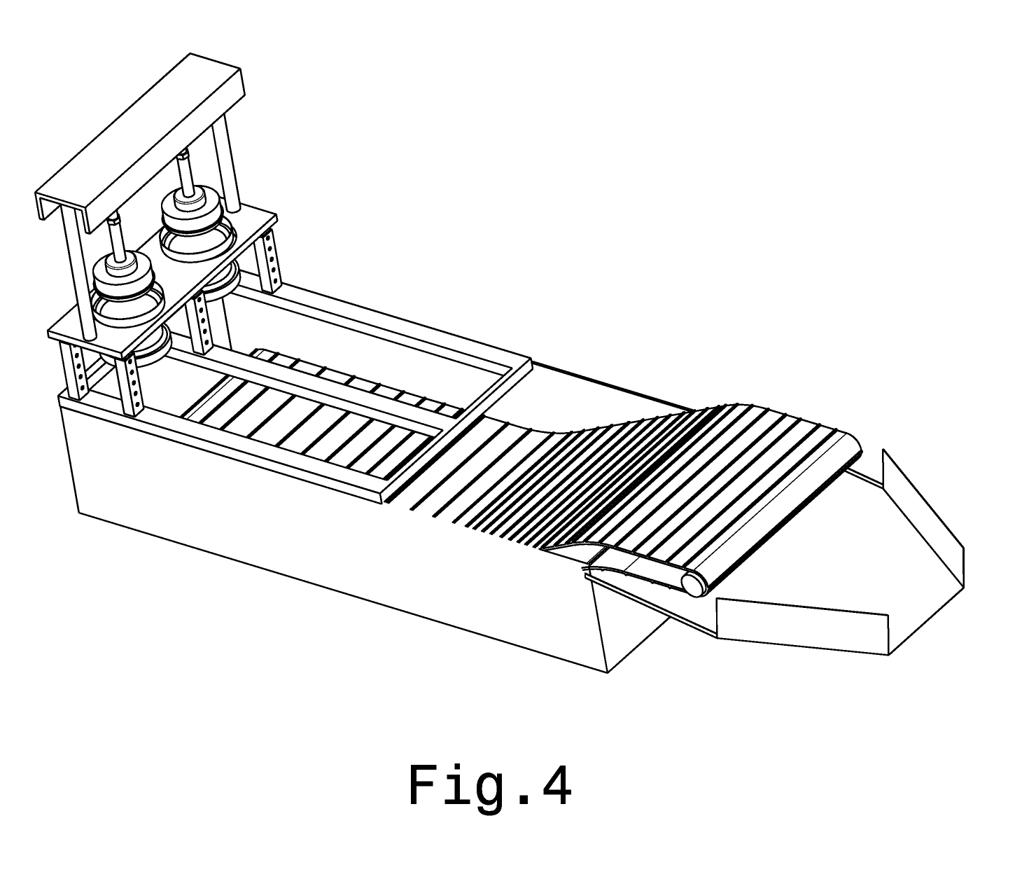

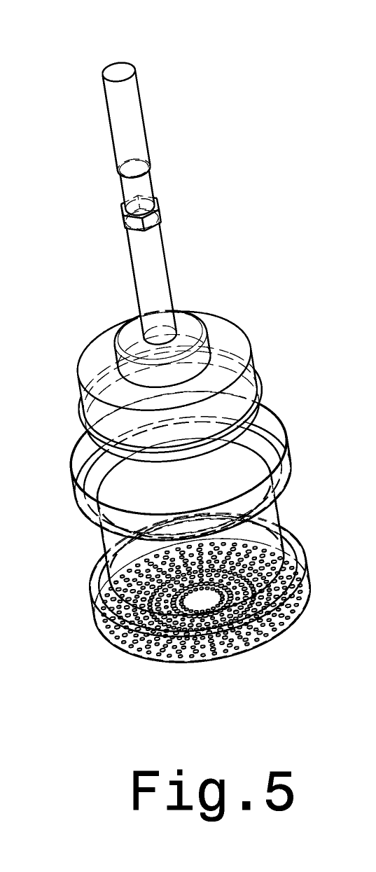

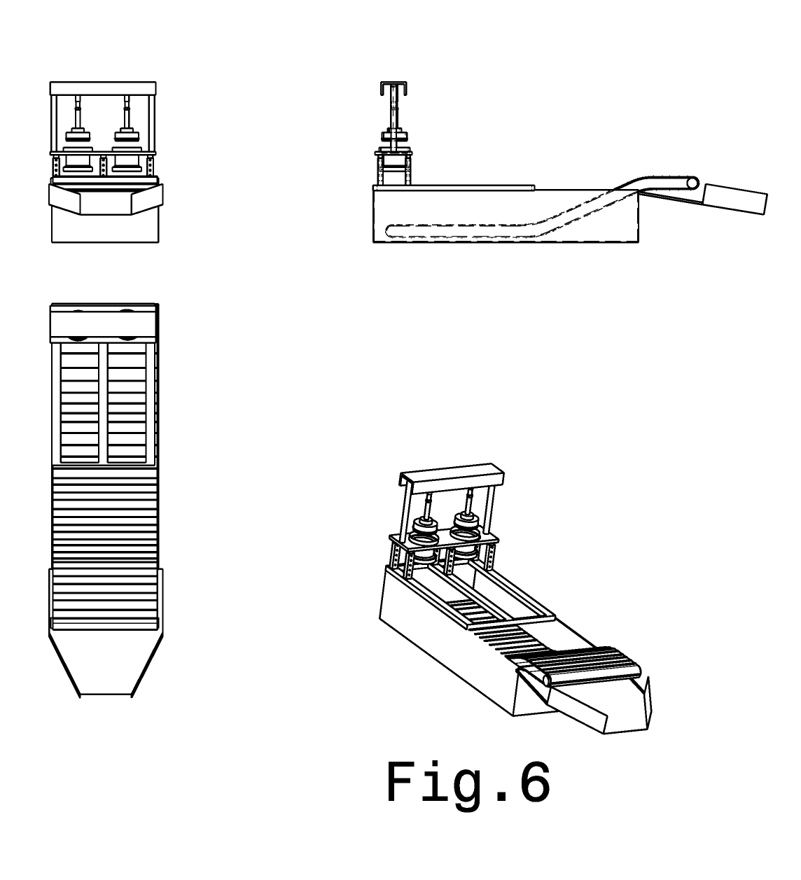

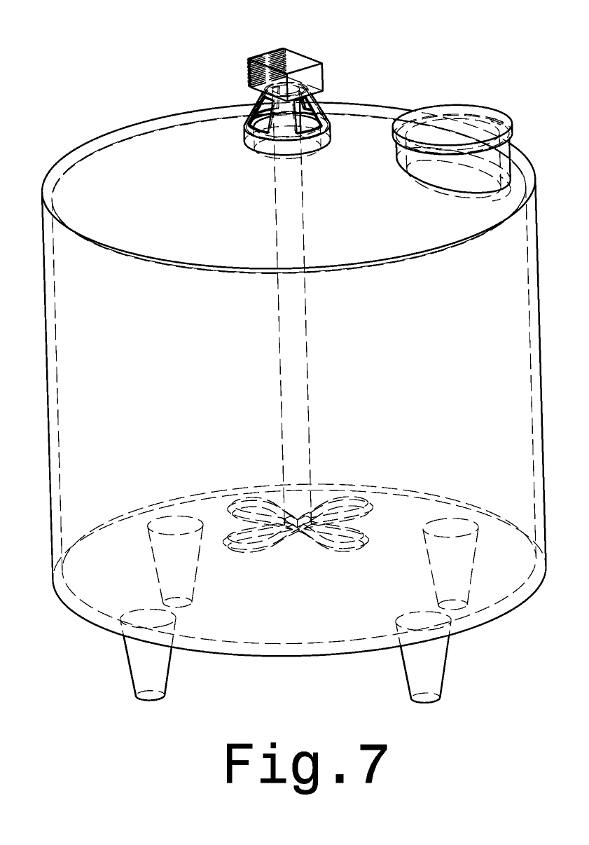

The first section of this line is dissolving section in which the starch dissolution in water occurs. (FIG. 3 number 9) In the next section, the starch bakes under indirect heating in two-shell storage by using hot waters. Solution of starch and water would be under indirect heat; in the same time in the same storage a mixer is working, therefore we would have a uniform solution of starch and water. (FIG. 3 number 10)

This section comprises of heaters, mixers and storages.

After baking the solution of starch and water, it would pour in net pots (FIG. 3 number 11) and a Pneumatic mechanism (FIG. 3 number 12) would press it and make fiber shape starches. There is a cold-water pool (FIG. 3 number 13) below net-pots in which fibers would pour into it. By contacting cold water, fiber starch would be cold, hard and formed.

They would come out from the pool by a conveyer (FIG. 3 number 14).

Until now, the frozen syrup and cold fibers of starch are ready.

The third section of the production line (FIG. 1 number 3) is a special mixer in which the frozen syrup from the first section and fiber starch from the second section would mix. Some other additives such as fruit pieces can be add to the product in this step too.

This mixer consists of electro motors, helical blades and storages.

There are two storages in this section in which there is a helical blade in each of them, mixing fiber starch and frozen syrup occurs in the higher storage with higher speed and after mixing, the mixture would pour into lower storage for being kept inform in which the speed of mixing is lower

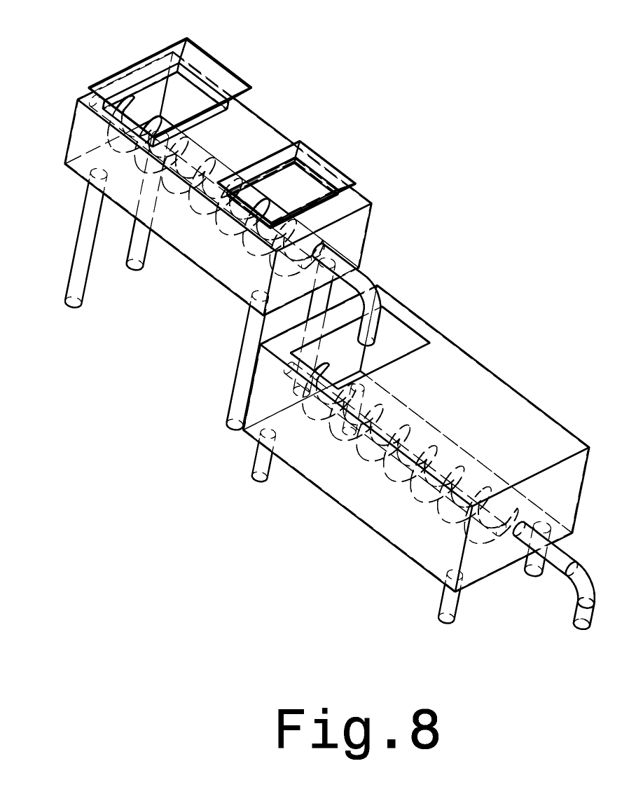

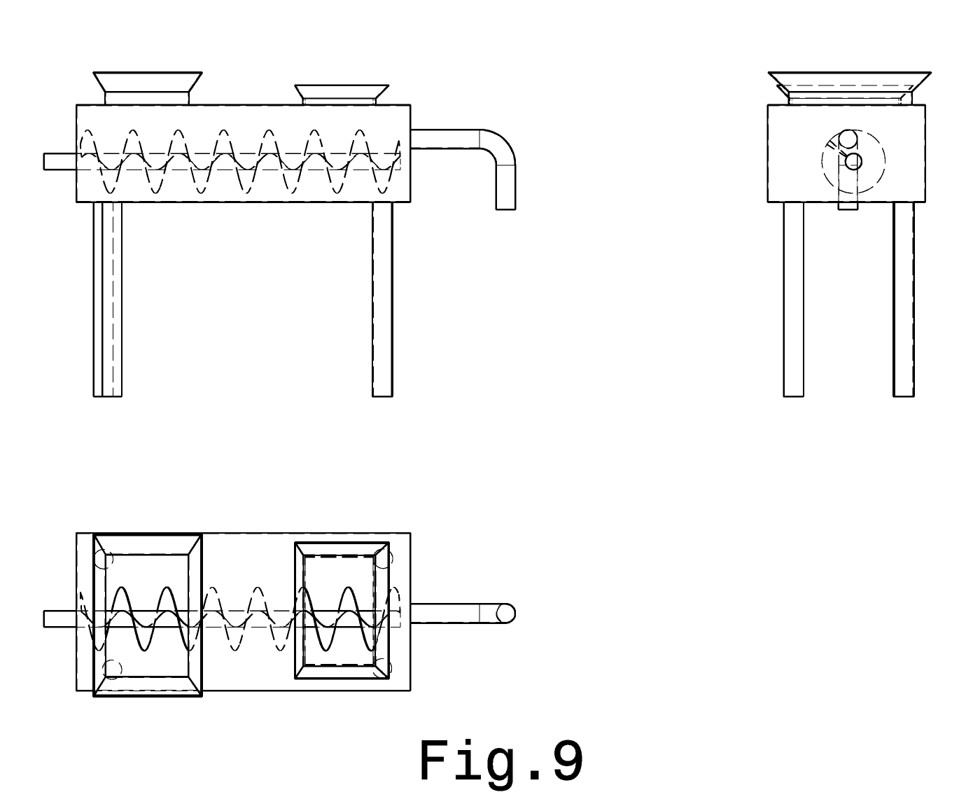

The blades of this mixer have helical form so the formed fiber starches will not crush (FIG. 8 and FIG. 9)

After mixing the syrup and the fiber starch, the product is ready for packing.

The ice noodle would sterilize before packaging with a sterilizer machine.

Consumables:

Starch: the starch used in this process, is different from ordinary starches.

We produce a modified starch, which is resistant against coldness. The way of baking starch is different from traditional production process. In traditional way the starch will bake in a big pot under direct heating which the heat would not distributed equally in this way. In this invention, baking would be under indirect heating in some storage by using hot vapors. (Baking time and the maximum temperature during heating which are very important in this process are under control)

In the next step, we mix water, sugar and stabilizer and pieces of fruits or any other flavors together and warm them in storage with pre heater machine for almost 30 minutes to have a uniform mixture. Then the mixture will pasteurize in a machine in 83° C. and it then it will be homogenized under 200 bar pressure therefore we will have an equal mixture.

After these steps the mixture will bring out from continues freezers in −18° C. in next step the frozen mixture will combined with cold starch fibers in a special mixer the flavors or fruit pieces can be add to the product in other mixture which is designed for mixing ice-noodle (design of blades and the pitches are computed) these steps will take about 30 minutes and causes uniformity in fibers, syrup and taste.

The last step is packing the product with fillers under controlled pressure the durability of this product will be almost 6 month, which is very positive for this industry.

What is claimed is:

1- Production Line And Method For Making Ice-Noodle comprising:
A line for making syrup, a line for making fiber starch and a mixer with helical blades

2- The line for making syrup of claim 1 consists of:
Storages, mixers, pumps, pasteurizer, Homogenizer and mixer-freezers

3- The line for making fiber starch of claim 1 consists of:
Dissolving section, two shells storage for baking under indirect heat, Press machine, cold-water pool and conveyer

4- Mixer with helical blades of claim 1 consists of two storages in which there is a helical blade in each of them, mixing fiber starch and frozen syrup occurs in the higher storage with higher speed and after mixing, the mixture would pour into lower storage for being kept inform in which the speed of mixing is lower.

5- this invention further comprising methods for making industrial ice noodle by using Starch, water and sugar syrup, fruit pieces, flavors such as vegetable distillates, pasteurized saffron etc.

6- The method of claim 5, further comprising:
Solving starch in enough water and baking it with indirect heat in 93° C. by vapor in two shells storage and then pouring baked starch in net-pots and pressing it with a pneumatic mechanism for making fibers and then pouring fibers in cold-water and taking them out from the water by a conveyer

7- The method of claim 5, further comprising, making thick syrup with sugar and water by mixing them in a mixer and then pasteurize and homogenize the solution and making it frozen in some mixer-freezers.

8- The method of claim 5, further comprising, mixing the fiber starch and frozen syrup together automatically in a machine for almost 30 minutes.

9- The method of claim 5, further comprising, mixing concentrate and crash fruit with mixture by employing special temperate and time which leads to quality and suitable texture.

10- The method of claim 5, further comprising:
Mixing vegetable distillates, pasteurized saffron, pasteurized fruit etc. with ice noodle

11- The process of claim 5, further comprising, sterilizing the ice noodles before packaging
